(19) United States
(12) Patent Application Publication
(10) Pub. No.: US 2016/0170841 A1
(43) Pub. Date: Jun. 16, 2016

(54) Non-Disruptive Online Storage Device Firmware Updating

(71) Applicant: NetApp, Inc., Sunnyvale, CA (US)

(72) Inventors: Gregory A. Yarnell, Wichita, KS (US); Leslie Russum, Broomfield, CO (US); Pamela Delaney, Wichita, KS (US)

(21) Appl. No.: 14/568,176

(22) Filed: Dec. 12, 2014

(51) Int. Cl. G06F 11/14; G06F 9/445

(52) U.S. Cl. CPC G06F 11/1469; G06F 11/1451; G06F 8/65

(57) ABSTRACT

A system, method, and computer program product for performing a non-disruptive service action to a storage device. A storage system with a volume receives a firmware update for storage devices supporting the volume. A controller checks whether a storage device from the volume may go offline without interrupting regular input/output with the volume. The update may proceed if the volume will not enter a failure state. The volume continues responding to input/output requests while the service action occurs. The storage device is taken offline, the update occurs, and writes to the storage device are tracked during the offline period. After the storage device is back online, any sections of the storage device that have changed due to the tracked writes are rapidly reconstructed, bringing the storage device back to an optimal state in a shorter period of time than otherwise possible, while still allowing input/output during the update process.

### TECHNICAL FIELD

The present description relates to data storage and, more specifically, to systems, methods, and machine-readable media for non-disruptive maintenance of storage devices.

### BACKGROUND

A storage volume is an entity that is provisioned from a storage system consisting of one or more storage devices, and may provide one or more logical drives to a user. Typically, a storage volume utilizes some form of data redundancy, such as by being provisioned from a redundant array of independent disks (RAID) or disk pools. The storage devices that make up the storage volume typically run firmware that provides the control program(s) for the storage devices. Firmware can be periodically updated, for example by the manufacturer of the storage devices, to address technical issues that have arisen or to provide improvements that have been developed.

When a firmware update is distributed to operators of the storage devices, the operators typically must take the volume that is supported by those storage devices offline. The firmware for the storage devices is then updated while the volume is offline. Placing the volume that is supported by the storage devices offline is a disruptive activity, however, which requires applications using the volume and its associated storage devices to be suspended until the updates are done and the volume is back online.

Further, the act of taking individual storage devices out of service and reconstructing those storage devices after updating, for example by reconstructing the redundancy of the underlying RAID disks or disk pools, requires a lengthy period of time because the reconstruction may involve the entire storage device. This makes it impractical to serialize the update process when there are many storage devices requiring the same update and reconstruction. During the reconstruction process, the storage volume is also susceptible to additional storage device failures and possible data loss. Accordingly, despite the use of conventional firmware updating techniques, the potential remains for further improvements that, for example, result in non-disruptive updates that enable the storage volume to continue operating (continuing application input/output) during the update and to reduce the period of time during which updating occurs.

### BRIEF DESCRIPTION OF THE DRAWINGS

The present disclosure is best understood from the following detailed description when read with the accompanying figures.

FIG. 1 is an organizational diagram of a data storage architecture according to aspects of the present disclosure.

FIG. 2A is a schematic diagram of a computing architecture performing a method of write tracking during a service action according to aspects of the present disclosure.

FIG. 2B is a memory diagram of a change log suitable for use in a method of write tracking according to aspects of the present disclosure.

FIG. 2C is a memory diagram of a change log suitable for use in a method of write tracking according to aspects of the present disclosure.

FIG. 3 is a flow diagram of a method of performing a non-disruptive service action to a storage device according to aspects of the present disclosure.

FIG. 4 is a flow diagram of a method of performing a non-disruptive service action to a storage device according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for performing a non-disruptive service action to a storage device. The techniques herein enable the volume which the storage device supports to continue responding to input/output requests while the service action (e.g., a firmware update) occurs, as well as enable the storage device to return to online status in a shorter period of time. In an example, a storage system with a storage volume receives a firmware update for one or more storage devices that support the volume. In an embodiment, the firmware update (or other service action) specifies a minimum redundancy desired during the update, e.g. RAID 5 or RAID 6.

In the example, after receiving the update, a controller of the storage system checks whether a storage device from the storage volume may be taken offline without interrupting regular system/application input/output (I/O) with the storage volume. If the controller determines that the storage volume will not enter a failure state should a storage device be taken offline for updating, the controller allows the update process to proceed according to embodiments of the present disclosure.

With the update process allowed to proceed in the example, the controller reserves one or more resources for use with the update and subsequent process to bring the storage device back to its optimal state. The resources could include processing resources, memory resources, bandwidth resources, and rapid reconstruction resources, to name a few examples. The controller takes the first storage device, from the one or more storage devices that need the firmware update, offline. With the storage device offline, the firmware update is performed. While the storage device is offline, the controller takes advantage of the redundancy of the storage volume to enable data access to the storage volume during the update, for example by tracking actions directed toward data in particular sections of the offline storage device and providing requested data that is in the offline storage device from a redundant source.

After the firmware has been updated for the storage device that is offline, the controller initiates a rapid reconstruction process that focuses storage device reconstruction on those sections of the storage device that would have changed during the offline period, as indicated by the tracked actions directed towards the storage device while offline. This reduces the period of time necessary to bring the storage device back to the optimal state by not wasting time and resources on reconstructing sections of the storage device that would not have changed since going offline.

The storage device reenters an optimal state after rapid reconstruction and reenters service with the storage volume. Where there are multiple storage devices supporting the given volume, the controller then turns to the next storage device and performs the same series of operations. In this manner, all of the storage devices subject to the firmware update may be sequentially updated without interrupting regular I/O operations of the storage volume (e.g., the storage volume may remain in an online state during the updates). Since the storage volume's storage devices may hereby be updated while the volume remains online, users are more likely to keep the storage system's storage devices up to date with the latest code, thus reducing the chance of any code defects (from outdated and/or faulty firmware, for example) impacting storage operations.

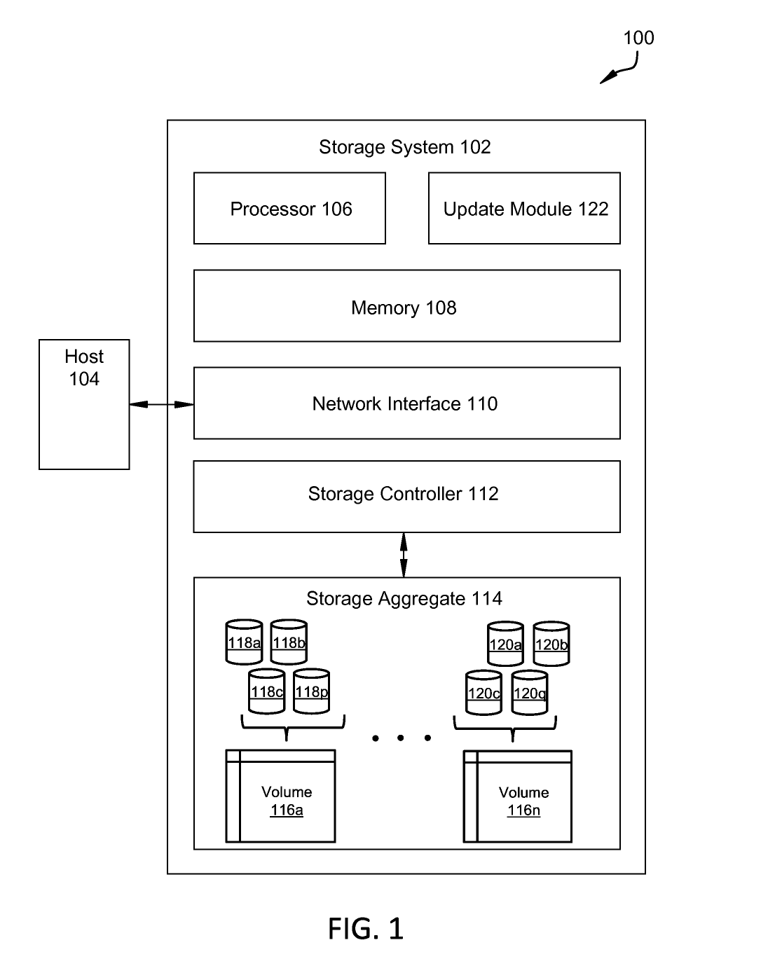

A data storage architecture 100 is described with reference to FIG. 1. The data storage architecture 100 includes a storage system 102 that processes data transactions on behalf of other computing systems including one or more hosts, exemplified by host 104. Although there may be a plurality of hosts, FIG. 1 is described with respect to one host 104 for simplicity of discussion, though it will be recognized that these principles apply to multiple hosts. The storage system 102 may receive data transactions (e.g., requests to read and/or write data) from the host 104, and take an action such as reading, writing, or otherwise accessing the requested data. For many exemplary transactions, the storage system 102 returns a response such as requested data and/or a status indictor to the host 104. The storage system 102 is merely one example of a computing system that may be used in conjunction with the systems and methods of the present disclosure.

The storage system 102 is a computing system and, in that regard, may include a processing resource 106 (e.g., a microprocessor, a microprocessor core, a microcontroller, an application-specific integrated circuit (ASIC), etc.), a transitory and/or non-transitory computer-readable storage medium 108 (e.g., a hard drive, flash memory, random access memory (RAM), optical storage such as a CD-ROM, DVD, or Blu-Ray device, etc.), and a network interface device 110 (e.g., an Ethernet controller, wireless communication controller, etc.) operable to communicate with the host 104 over a network or without using a network (e.g., directly connected).

The storage system 102 also includes one or more storage controllers 112 in communication with a storage aggregate 114. The storage aggregate 114 includes one or more logical volumes 116a through 116n. The logical volume 116a includes any number of suitable storage devices, illustrated in FIG. 1 as storage devices 118a-118p, using any suitable storage medium including electromagnetic hard disk drives (HDDs), solid-state drives (SSDs), flash memory, RAM, optical media, and/or other suitable storage media. The storage volume 116n similarly includes any number of storage devices 120a-120q. The storage aggregate 114 may include devices of single type (e.g., HDDs) or may include a heterogeneous combination of media (e.g., HDDs with built-in RAM caches). The storage controller 112 exercises low-level control over the storage devices 118a-118p and 120a-120q in order to execute (perform) data transactions on behalf of the host 104, and in so doing, may group the storage devices for speed and/or redundancy using a virtualization technique such as RAID or disk pools. At a high level, virtualization includes mapping physical addresses of the storage devices into a virtual address space and presenting the virtual address space to the host 104. In this way, the storage system 102 represents the group of devices as a single device, often referred to as the volumes 116a-116n. Thus, a host 104 can access a volume 116 without concern for how it is distributed among the underlying storage devices 118a-118p and 120a-120q.

In an embodiment, the storage devices 118a-118p of logical volume 116a are a plurality of HDDs arranged in a Redundant Array of Independent Disks (RAID) configuration (e.g., RAID 1, 3, 5, or 6). In another embodiment, the logical volume 116a includes a plurality of SSDs and/or random-access memory configured as a RAM disk. This is a common configuration for a storage system 102 in part because of the increased performance of SSDs with respect to HDDs. In a further embodiment, the storage devices 118a-118p are arranged in a disk pool. In an alternative embodiment, the logical volume 116a includes a combination of RAID HDDs or SSDs, RAM disk(s), and disk pools. Similarly, the storage devices 120a-120q of logical volume 116n may be arranged in a RAID array, a RAM disk, or a disk pool to name a few examples. As will be recognized, these configurations are merely exemplary and the storage aggregate 114 may include any suitable storage device or devices in keeping with the scope and spirit of the present disclosure. The logical volumes 116a-116n may range from one or more volumes on a single physical device to ranging across multiple physical devices.

The storage system 102 receives memory transactions from the host 104 directed to the data of the storage aggregate 114. During operation, the storage system 102 may also generate memory transactions independent of those received from the host 104. Memory transactions are requests to read, write, or otherwise access data stored within a computer memory such as the storage aggregate 114, and are often categorized as either block-level or file-level. Block-level protocols designate data locations using an address within the storage aggregate 114. Suitable addresses include physical addresses, which specify an exact location on a storage device, and virtual addresses, which remap the physical addresses so that a program can access an address space without concern for how it is distributed among underlying devices of storage aggregate 114. Exemplary block-level protocols include iSCSI, Fibre Channel, and Fibre Channel over Ethernet (FCoE). iSCSI is particularly well suited for embodiments where data transactions are received over a network that includes the Internet, a Wide Area Network (WAN), and/or a Local Area Network (LAN). Fibre Channel and FCoE are well suited for embodiments where host 104 is coupled to the storage system 102 via a direct connection. A Storage Attached Network (SAN) device is a type of storage system 102 that responds to block-level transactions.

In contrast to block-level protocols, file-level protocols specify data locations by a file name. A file name is an identifier within a file system that can be used to uniquely identify corresponding memory addresses. File-level protocols rely on the storage system 102 to translate the file name into respective memory addresses. Exemplary file-level protocols include SMB/CFIS, SAMBA, and NFS. A Network Attached Storage (NAS) device is a type of storage system 102 that responds to file-level transactions. It is understood that the scope of present disclosure is not limited to either block-level or file-level protocols, and in many embodiments, the storage system 102 is responsive to a number of different memory transaction protocols.

An update module 122 provides an updating service to the individual storage devices of the storage system 102, thereby enabling the storage system 102 to non-disruptively perform service actions to one or more individual storage devices (e.g., 118a-118p or 120a-120q) while the storage volume(s) 116a-116n are still online. The update module 122 may be composed of hardware, software, or some combination of the two, for example executed by the processor 106 and/or the storage controller 112. In the embodiment illustrated in FIG. 1, the update module 122 is located with the storage system 102. One example of a service action is a firmware update. For simplicity of discussion, discussion of the various figures and embodiments below will be with respect to a firmware update, though other types of service actions may also benefit from aspects of the present disclosure as will be recognized.

The storage system 102 may receive a set of files which include, for example, a firmware update, from a remote system, for example from the host 104 or another system, via the network interface 110. The firmware update may alternatively be provided via removable media, such as a USB stick or a compact disc to name just a couple examples. In an embodiment, the firmware update (or other service action) may also specify a minimum redundancy desired during the update, e.g. RAID 5 or RAID 6. After the storage system 102 receives a firmware update, the update module 122 is used to check volume availability for performing the update, as well as redundancy level possible during the service action. This is because, according to embodiments of the present disclosure, the update module 122 sequentially takes storage devices that qualify for the firmware update offline while the logical volume remains online. As will be recognized, the storage aggregate 114 may include multiple logical volumes 116a-116n that are redundant volumes and which have storage devices that qualify for a firmware update. In such embodiments, one storage device in each volume may be taken offline for firmware updates at a time—e.g., one storage device per volume so that multiple volumes have a storage device being updated at approximately the same or near the same point in time. The discussion below will be with respect to an exemplary volume for simplicity of discussion, though it is applicable in contexts where additional volumes exist as well.

The update module 122 determines which storage devices are the targets for the firmware update. The particular storage devices to be updated may have been previously identified by the source of the firmware, an operator of the storage system 102, or some other source. Alternatively, the update module 122 may query the storage devices to which it has access to identify which storage devices of the logical volume 116a are targeted for the firmware update, for example that the storage devices are storage devices which the manufacturer or other firmware source intended to receive the update.

In the logical volume 116a, with one or more storage devices qualifying for the firmware update, the update module 122 determines whether the logical volume 116a can still operate in a degraded mode while the firmware is updated for an offline storage device. According to embodiments of the present disclosure, a “degraded mode” for a logical volume 116 is a fallback mode where usage of the logical volume 116 is still possible, but redundancy is reduced and a higher load is placed on the system while reconstructing requested data from alternative sources to the storage device that is offline, such as exists for RAID arrays. For example, redundancy may include parity and/or minoring, and in an example where the storage devices 118a-118p and 120a-120q minor data (e.g., RAID 1, RAID 10, etc.), the determination includes determining whether at least one of the mirrored storage devices 118a-118p and 120a-120q involved in a data transaction is operable. If so, then the transaction can be completed using the operable storage device(s) from among devices 118a-118p and 120a-120q and the data can be mirrored later.

In an example where the volumes 116a-116n use a parity redundancy scheme (e.g., RAID 5, RAID 6, etc.), the determination includes determining whether sufficient storage devices 118a-118p and 120a-120q are operable to reconstruct the data using the parity information. For example, RAID 5 supports a degraded mode when one storage device 118 of the volume 116a is inoperable, and RAID 6 supports a degraded mode when one or two storage devices 1118 of the volume 116a are inoperable. In degraded mode, enough of the data and parity information is available on the storage devices 118 to access the entire address space of the volume 116a, although doing so may entail reconstructing some data using the parity information. To read data in degraded mode, the parity information is used to reconstruct any data stored on an inoperable storage device 118. If the inoperable storage device(s) 118 only contained parity data, no reconstruction may be needed. To write data in a degraded mode, a combination of data and parity information is written to the operable storage devices 118. The portion of the data and/or parity information to be written to the inoperable storage device 118 may be postponed until functionality is restored.

The update module 122 may query the storage aggregate 114, for example, by querying the storage controller 112, to determine whether the volume 116a with storage devices to be updated can operate in a degraded mode. This query may involve querying to determine whether the storage devices are part of a redundant volume group, the storage devices are unassigned, one or more of the storage devices have failed (which could be due, for example, to faulty firmware that is being updated), or there are no other exclusive operations occurring in firmware of the storage devices that could prevent or delay a service operation. In embodiments where there are multiple volumes with storage devices to update, and/or one or more storage devices that are not part of a volume (e.g., because they are still unassigned), the update module 122 may sequentially update these storage devices to spread the overhead of internal operations over a longer period of time.

If the update module 122 determines that the logical volume 116a will not fail if a storage device is taken offline for updating, then the update module 122 proceeds with taking a storage device offline. For example, the update module 122 may sequentially take the storage devices 118a-118p to update them. Prior to doing so, the update module 122 may also set up one or more preconditions useful in optimizing a reconstruction path for the one or more storage devices being updated. The update module 122 may do this prior to updating any storage devices; alternatively, the update module 122 may do so prior to taking any individual storage device offline in sequential fashion. The preconditions may include blocking the user and/or application from performing any actions to the volume during the update process that would prevent rapid reconstruction of the storage devices after updating, such as preventing users of the logical volume 116a from transferring volume ownership to name an example. The update module 122 may also reserve one or more resources useful in updating and reconstruction, such as processing resources, memory resources, bandwidth resources, and rapid reconstruction resources, to name a few examples.

The update module 122 may begin with the first storage device, in this example storage device 118a, and take it offline. With the first storage device offline, the update module 122 updates the firmware of the storage device. During the time that the storage device is offline, the update module 122 may track, or may cause the storage controller 112 to track, all writes directed towards the offline storage device. After the firmware is updated, the update module 122 brings the first storage device back online and reintegrates the storage device with the volume it is associated with (unless it is unassigned). The data on the storage device is refreshed via a rapid reconstruction operation that limits reconstruction to those sections of the storage device that may have changed as indicated by the tracked writes during the offline period, and which is accomplished utilizing volume redundancy information.

Once the first storage device has returned to an optimal state, the update module 122 may turn to the next storage device of the logical volume 116a. The update module 122 repeats the above-noted operations with each storage device in the logical volume 116a until all of the storage devices for which the firmware updated is intended have received it. In an embodiment, the update module 122 may attempt a pre-designated number of attempts or for a set time period to update the firmware for any given storage device before moving on to a next storage device. This may occur, for example, where a storage device has failed in a manner that is not recoverable, e.g. where the failure was not firmware-related. The update module 122 may attempt, for example, two to ten times to repeat the update before moving on to the next storage device. When moving on, the update module 122 may additionally note the failure to update the storage device's firmware, and report this failure when it occurs or wait until the overall process is done and present a failure report that lists any other storage devices that also failed to update as well.

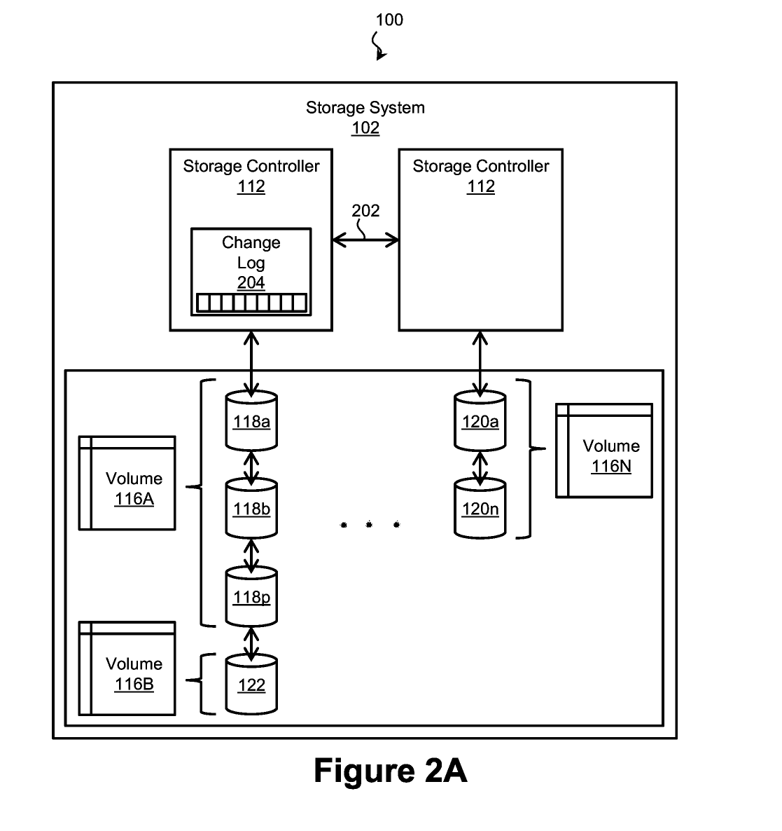

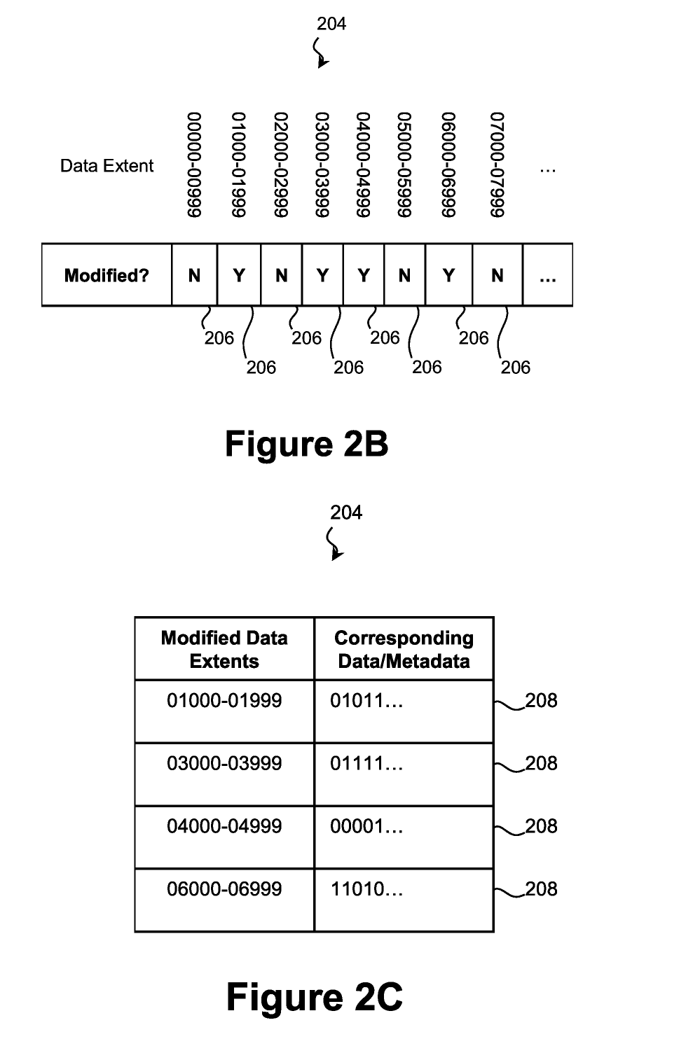

FIG. 2A is a memory diagram of a change log suitable for use in embodiments of the present disclosure. In an embodiment, FIG. 2A demonstrates an exemplary manner in which I/O operations may be tracked during an offline period for a storage device being updated.

A data transaction directed to data in a target volume 116, such as target volume 116A, is received at a storage controller 112 of a storage system 102. The data transaction may be received from a process running on a host 104, on the storage system 102, and/or on any other computing system.

In some embodiments, one or more storage controllers 112 of the storage system 102 may be designated as the owner(s) of the target volume 116A. Regarding ownership, in some examples, the storage controllers 112 of the storage system 102 are arranged in a redundant manner where a single storage controller 112 is designated as the owner of a volume 116. In these examples, to avoid data collisions, only the storage controller 112 that has ownership of a volume 116 may directly read to or write from a volume 116. To provide redundancy, should the owning storage controller 112 become overburdened or fail, ownership may be transferred to the other storage controllers 112 of the storage system 102. The non-owning storage controllers 112 may support the owning controller by forwarding received data transactions to the owning storage controller 112 via an inter-controller bus 202 instead of performing the transactions directly. The data transaction may be received at the owning storage controller 112 directly or via a transfer from another storage controller 112 by a channel such as an inter-controller bus 202. In the embodiment of FIG. 2A, each storage controller 112 has ownership of those volumes 116 shown as directly connected to the storage controller 112.

In FIG. 2A, the storage controller 112 identifies the storage devices 118a-118p of the target volume 116A and determines whether the storage devices 118a-118p are operable to perform the data transaction. Determining whether a particular storage device 118 is operable may include determining whether it is undergoing a service action, whether it is present, whether it has power, whether it is correctly connected to the storage system 102, whether it is capable of receiving communications, and/or whether it is operating a mode that allows it to perform the transaction (e.g., a storage device may be in a read-only mode and unable to perform a write transaction). The determination may also include any other determination that may weigh on the ability of the storage device 118 to attempt or complete the data transaction. The determination may include a separate polling step where the storage controller 112 requests status from the storage device 118. Additionally or in the alternative, the storage controller 112 determines whether a storage device 118 is operable by attempting to perform the data transaction and monitoring for a response from the storage device 118 indicating whether its portion of the transaction completed successfully. In some embodiments, an “inoperable” flag may have been set at the beginning of a service action to the drive, e.g. when it is brought offline by the update module 122. Accordingly, the determination of whether the storage devices are operable may include checking the status of one or more “inoperable” flags. Consequently, upon determining that a storage device 118 is not operable, the storage controller 112 may set a corresponding “inoperable” flag.

If all of the storage devices 118a-118p of the target volume 116A are operable to perform the transaction, the storage controller 112 performs the data transaction and reports the success to the provider of the data transaction. This may include providing data read from the storage devices 118a-118p and/or providing an indicator of a successful write.

If some of the storage devices 118a-118p are not able to perform their portions of the data transaction, e.g. because one of them has been brought offline to perform the service action, the storage controller 112 determines whether enough storage devices 118a-118p are operable to perform the data transaction, albeit with reduced redundancy. Redundancy may include parity and/or minoring, and in an example where the storage devices 106 mirror data (e.g., RAID 1, RAID 10, etc.), the determination may include determining whether at least one of the mirrored storage device 118a-118p involved in the data transaction is operable as described above. In an example where the volume 116 uses a parity redundancy scheme (e.g., RAID 5, RAID 6, etc.), the update module 122 may further determine whether sufficient storage devices 118a-118p are operable to reconstruct the data using the parity information as described above.

If it is determined that there are not enough operable storage devices 118a-118p of the volume 116A to perform the data transaction even with reduced redundancy, then the storage controller 112 may cancel the data transaction at the operable storage devices 118a-118p and may report an error to the transaction provider. If it is determined that enough of the storage devices 118a-118p are operable to perform the data transaction with reduced redundancy, the storage controller 112 identifies and characterizes the address space stored by the inoperable storage device(s) 118. The characterization is used to track modifications to data in the address space so that if the inoperable storage device(s) 118 become operable, the modified portions of the data set can be selectively reconstructed.

The storage controller 112 initializes a change log 204 for tracking the address space of the inoperable storage device(s) 106 if one has not already be initialized. The change log 204 contains entries recording whether data associated with the address space has been modified since the inoperable storage device(s) became inoperable. In its initial state, the change log 204 records that no data has been modified. However, as subsequent data transactions are performed, the change log 204 records the modified address ranges (modified extents) and/or the respective data so that the data can be written to the inoperable storage device(s) 118 should they come back online. The change log 204 may take the form of bitmap, a hash table, a flat file, an associative array, a linked list, a tree, a state table, a relational database, and/or other suitable memory structure. The change log 204 may divide the address space according to any granularity, and in various exemplary embodiments divides the address space into 1 kB, 4 kB, 64 kB, and/or 1 MB address ranges (extents).

An exemplary change log 304 is illustrated in FIG. 2B. The exemplary change log 204 is structured as a bitmap with each data extent of the address space having an associated entry 206. Each entry 206 records whether the data within the corresponding extent has been modified since the storage device 118 became inoperable (e.g., was taken offline). A further exemplary change log 204 is illustrated in illustrated in FIG. 2C. The change log 204 of FIG. 2C is structured as a sorted list of those data extents that have been modified since the storage device 118 became inoperable. In the illustrated embodiment, each entry 208 of the change log 204 includes the data extent and the respective data values and/or metadata to be stored there. It is understood that these arrangements of the change log 204 are exemplary, and other formats for the change log 204 are both contemplated and provided for.

The change log, of any form, is useful for rapidly reconstructing sections of a storage device 118 that changed due to writes while the storage device 118 was offline receiving a service action such as a firmware update. Returning to FIG. 2A, when the storage controller 112 determines that the storage device 118 that was brought offline for the service action is back online, the storage controller 112 determines whether the data on the storage device 118 matches the dataset stored at the time it was taken offline. If the data on the storage device 118 does not match the dataset prior to going offline, a full reconstruction of the volume 116A may be performed.

If the data does substantially match the prior dataset, a partial or selective reconstruction may be performed. In an exemplary partial reconstruction, the storage controller 112 identifies those data extents that were modified while the storage device 118 was offline using the change log 204. The storage controller 112 reconstructs or otherwise determines the data (including metadata) values to be stored at the data extents in the change logs. In some embodiments, the data values are stored in the change log 204 and are determined therefrom. In some embodiments, data and/or parity data is read from the other storage devices 118 of the volume 116A to recreate the data values (including parity values) to be written to the storage device 118. As the reconstruction is in progress, the storage controller 112 may track those data extents for which data values have been written. In one such embodiment, the storage controller 112 tracks reconstructed extents by updating the change log 204 entries to record those extents whose data has been recreated and stored. In a further embodiment, the storage controller 112 maintains a separate log of reconstructed data. By tracking reconstructed data, if subsequent transactions read from or write to the extents that have been reconstructed, the device 118 can be used to service the transaction even if the reconstruction is still ongoing. Upon completion of the rapid reconstruction process, the storage controller 112 may remove the change log 204. Although discussed with respect to volume 116A, it will be recognized that this is for purposes of simplicity of discussion only, and that the above description may apply to the other volumes 116 as well.

In situations where there are no writes directed towards the given storage device 118 while it is offline being updated, no matter how the update module 122 performs tracking, no data recovery is necessary when the given storage device 118 is placed back into service and online.

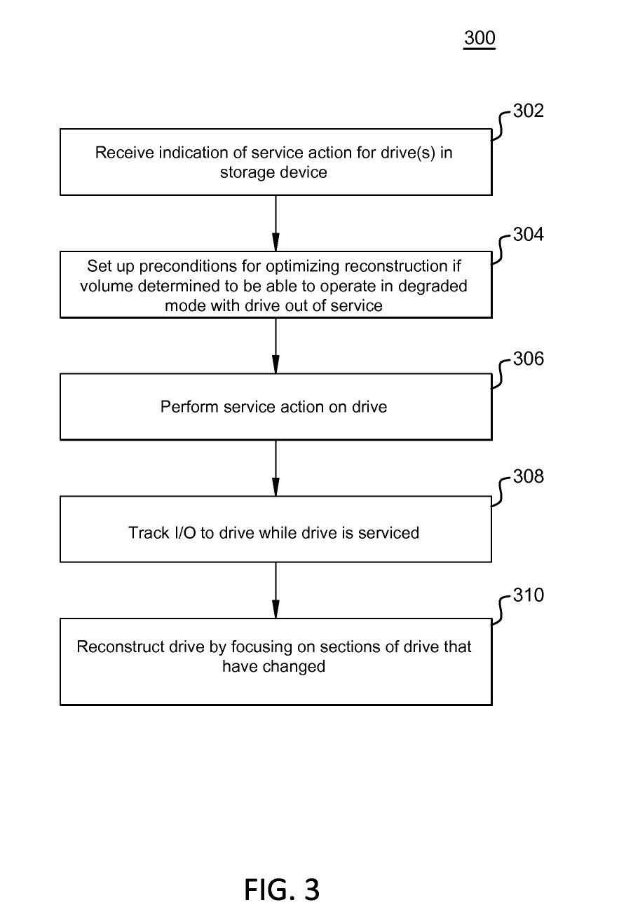

Turning now to FIG. 3, a flow diagram is illustrated of a method 300 of performing a non-disruptive service action to a storage device, such as one or more storage devices 118a-118p, 120a-120q of storage system 102 of FIG. 2, according to aspects of the present disclosure. It is understood that additional steps can be provided before, during, and after the steps of method 300, and that some of the steps described can be replaced or eliminated for other embodiments of the method.

At step 302, the storage system 102 receives an indication of a service action to be performed to one or more storage devices of the storage aggregate 114. For example, the storage system 102 may receive a firmware update from an external source via network interface 110. The service action may specify a minimum redundancy desired during the update.

At step 304, the update module 122 sets up preconditions that will optimize the reconstruction of the storage volume that is supported by one or more storage devices that are targets of the firmware update, if the update module 122 determines that the affected volume will still be able to service transactions in a degraded mode while a storage device is taken out of service (offline) to perform the service action. The preconditions may include blocking the user (whether human user or application) from performing any actions to the volume during the update process that would prevent rapid reconstruction of the storage devices after updating, such as preventing users of the volume from transferring volume ownership. The update module 122 may also place a SCSI reservation on the storage device to be updated to make sure the update process is the only process sending I/O to the storage device during the update. The preconditions may also include the reservation of resources useful in firmware updating and reconstruction, such as processing resources, memory resources, bandwidth resources, and rapid reconstruction resources.

At step 306, the update module 122 causes the storage device to be taken offline and the service action, such as a firmware update, to be performed on the storage device. For example, the update module 122 may take the storage device offline, or direct the storage controller 112 to take the storage device offline and perform the update. The update may include, for example, pushing the firmware update to the storage device, resetting the storage device, and reloading an image of the storage device.

At step 308, the update module 122 tracks I/O operations to the target storage device while the target storage device is offline. As an example, the update module 122 tracks writes to the target storage device. The writes may be tracked according to one or more of the embodiments described above, to name a few examples.

At step 310, once the storage device is being brought back online, the update module 122 rapidly reconstructs the storage device, for example by focusing on sections of the storage device that need to change based on the writes tracked at step 308 instead of the entire storage device. After the storage device is reconstructed, the resources that had been reserved for the update may be released as part of an indication that the update for the storage device is complete. Alternatively or in addition, a notification may be generated.

Where the volume includes multiple storage devices, the update module 122 repeats steps 306-310 for each of the other targeted storage devices of a given volume. In an embodiment, a notification is generated after completion of the update and reconstruction for each storage device so that the system knows it may proceed to the next storage device (if any). As an alternative to releasing and re-reserving resources after each update, the resources may remain reserved as the update module 122 transitions to the next storage device, and remain reserved until the update is completed on all storage devices.

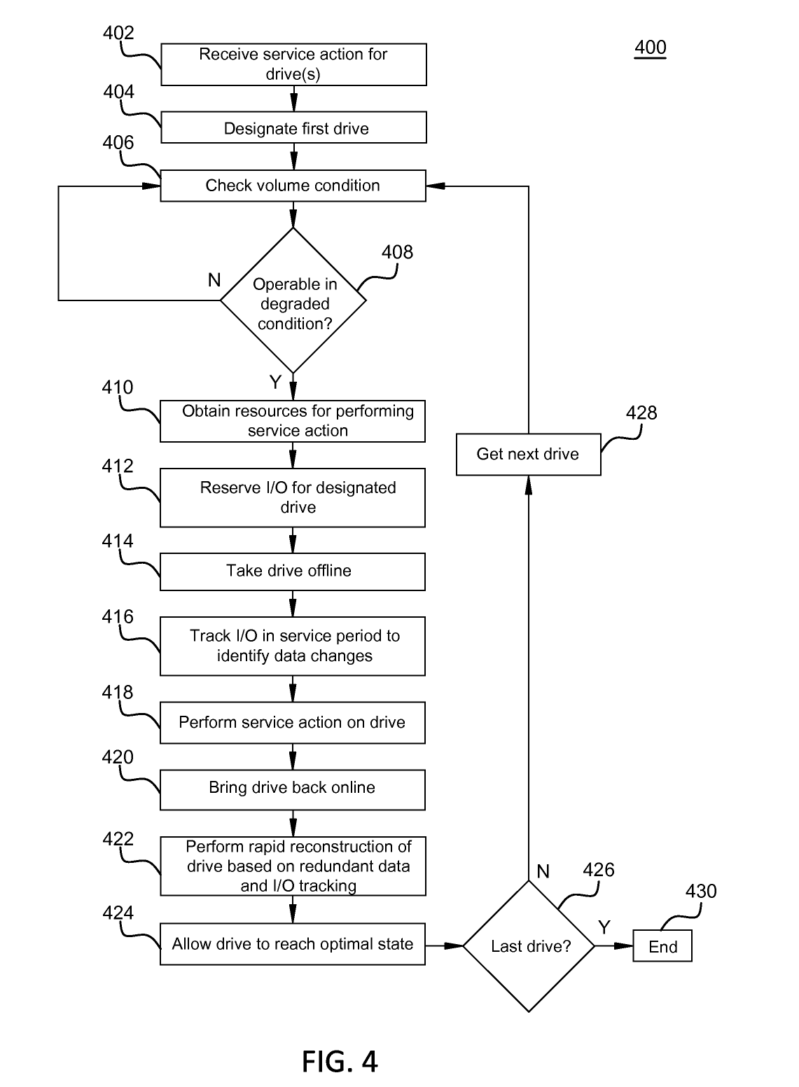

FIG. 4 is a flow diagram of a method 400 of performing a non-disruptive service action to a storage device according to aspects of the present disclosure. FIG. 4 illustrates an embodiment in which there are multiple storage devices that are targets for service actions, such as a firmware update.

At step 402, the storage system 102 receives an indication of a service action to be performed to one or more storage devices of the storage aggregate 114, as discussed with respect to step 302 of FIG. 3 above. The indication may include a firmware update, and firmware update may specify a minimum redundancy desired during the update.

At step 404, the update module 122 designates the first storage device to receive the firmware update. For example, the update module 122 may take as the first storage device the storage device with the lowest address range in the logical volume it supports. Alternatively, the update module 122 may designate as first a storage device that is currently available.

At step 406, the update module checks a condition of the logical volume supported by the designated storage device. This check is done to determine whether the logical volume can operate in a degraded mode while the firmware is updated for an offline storage device. The update module 122 may query the storage aggregate 114, for example, by querying the storage controller 112, to determine whether the volume or volumes with storage devices to be updated can operate in a degraded mode to determine whether the storage devices are part of an optimal redundant volume group, the storage devices are unassigned, one or more of the storage devices have failed (which could be due, for example, to faulty firmware that is being updated), or there are no other exclusive operations occurring in firmware of the storage devices that could prevent or delay a service operation. In embodiments where the service action also specifies a minimum redundancy level, this may involve the storage controller 112 determining whether a redundancy level of the volume supported by the storage device(s) receiving the service action will meet or exceed the specified redundancy level.

At decision step 408, the method 400 proceeds to step 410 if it is determined that the volume may operate in a degraded condition, and, for example, meet the specified redundancy level, or else returns to step 406 to check again whether the volume is capable yet of operating in a degraded condition.

At step 410, the update module 122 obtains one or more resources to perform the firmware update, for example by reserving computing and memory resources necessary for performing the update, tracking, and rapid reconstruction. This may also include setting up preconditions that will optimize the reconstruction of the storage volume, such as blocking the user (whether human user or application) from performing any actions to the volume during the update process that would prevent rapid reconstruction.

At step 412, the update module 122 reserves the I/O for the designated storage device, for example by placing a SCSI reservation on the storage device to be updated to make sure the update process is the only one sending I/O to the storage device during the update.

At step 414, the update module 122 takes the designated storage device offline, or causes another resource to take it offline.

At step 416, the update module 122 tracks I/O operations to the target storage device while the target storage device is offline. The writes may be tracked according to one or more of the embodiments described above, to name a few examples.

At step 418, while the update module 122 is tracking the I/O, the update module 122 (or the storage controller 112 or the processor 106) performs the firmware update on the designated storage device. The update may include, for example, pushing the firmware update to the storage device, resetting the storage device, and reloading an image of the storage device.

At step 420, once the firmware update is completed, the update module 122 causes the designated storage device to be brought back online.

At step 422, the update module 122 causes a rapid reconstruction of the designated storage device to occur. The update module 122 may perform the reconstruction, or instruct another resource such as the storage controller 112 to perform the rapid reconstruction. The rapid reconstruction may be performed, for example, by focusing on sections of the storage device that need to change based on the writes tracked during the offline period and data redundancy.

At step 424, the designated storage device returns to its optimal state. A notification may be generated, such as from the storage device, indicating to the update module 122 that the method 400 may continue.

At decision step 426, the update module determines whether there are additional storage devices in the volume that should receive the firmware update as well. If there are no more storage devices to receive the update, the method 400 proceeds to step 430 and ends. If there are more storage devices, for example that match a description provided with the firmware update, the method 400 proceeds to step 428.

At step 428, the update module 122 transitions and designates the next storage device for update, either by way of the next storage device in line by way of address or by availability, to name a couple examples. The method 400 then proceeds according to steps 406-426 as discussed above until all storage devices are either updated, or attempted updates have either timed out or exceeded a threshold number of attempts.

The present embodiments can take the form of an entirely hardware embodiment, an entirely software embodiment, or an embodiment containing both hardware and software elements. In that regard, in some embodiments, the computing system is programmable and is programmed to execute processes including those associated with performing a non-disruptive service action to a storage device such as the processes of method 400 of FIG. 4. Accordingly, it is understood that any operation of the computing system according to the aspects of the present disclosure may be implemented by the computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and Random Access Memory (RAM).

Thus, the present disclosure provides system, methods, and computer-readable media for performing a non-disruptive service action. In some embodiments, the method includes identifying a service action to be performed on a storage device of a volume, wherein the service action specifies a minimum redundancy of the volume. A redundancy level of the volume associated with performing the service action is determined. Further, the service action is performed when it is determined that the redundancy level associated with performing the service action complies with the minimum redundancy.

In further embodiments, the computing device includes a memory containing machine readable medium comprising machine executable code having stored thereon instructions for performing a method of storage device maintenance on a storage device of a volume; and a processor coupled to the memory. The processor is configured to execute the machine executable code to: identify a service action to be performed on a storage device of a volume, wherein the service action specifies a minimum redundancy of the volume. The processor also is configured to determine a redundancy level of the volume associated with performing the service action and perform the service action when it is determined that the redundancy level associated with performing the service action complies with the minimum redundancy.

In yet further embodiments the non-transitory machine readable medium having stored thereon instructions for performing a method of performing a service action to a storage device of a volume comprises machine executable code. When executed by at least one machine, the code causes the machine to: receive a service action for performance on a storage device of a volume that utilizes a redundant storage protocol; perform the service action when the volume supports operation in a degraded mode where the storage device is unavailable during a down time of the service action; and reconstruct, after completion of the service action, at least one section of the storage device that changed in response to an input/output operation during the down time.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising;
identifying a service action to be performed on a storage device of a volume, wherein the service action specifies a minimum redundancy of the volume;
determining a redundancy level of the volume associated with performing the service action; and
performing the service action when it is determined that the redundancy level associated with performing the service action complies with the minimum redundancy.

2. The method of claim 1, wherein the determining further comprises:
reconstructing at least one section of the storage device which changed during the service action.

3. The method of claim 2, further comprising:
tracking a write operation directed toward the storage device during the service action, wherein the reconstructing includes:
reconstructing a section of the storage device where the write operation is directed.

4. The method of claim 2, further comprising:
dividing the storage device into a plurality of logical block addresses (LBAs);
tracking one or more LBAs from among the plurality that are targets of write operations during the service action; and
limiting reconstruction to the one or more LBAs that were targets of the write operations during the service action.

5. The method of claim 2, further comprising:
obtaining processing resources for use in reconstructing the one or more LBAs; and
preventing another instance of reconstruction from occurring in response to the obtaining the processing resources for the service action.

6. The method of claim 1, further comprising:
reserving input/output operations to the storage device prior to performing the service action to hold any input/output operations to the storage device during the service action; and
releasing the reservation upon completion of the service action to the storage device.

7. The method of claim 1, further comprising:
querying a controller of the volume to determine the redundancy level.

8. A computing device comprising:
a memory containing machine readable medium comprising machine executable code having stored thereon instructions for performing a method of storage device maintenance on a storage device of a volume;
a processor coupled to the memory, the processor configured to execute the machine executable code to:
identify a service action to be performed on a storage device of a volume, wherein the service action specifies a minimum redundancy of the volume;
determine a redundancy level of the volume associated with performing the service action; and
perform the service action when it is determined that the redundancy level associated with performing the service action complies with the minimum redundancy.

9. The computing device of claim 8, wherein the processor is further configured to execute the machine executable code to:
reconstruct at least one section of the storage device which changed during the service action.

10. The computing device of claim 9, wherein the processor is further configured to execute the machine executable code to:
divide the storage device into a plurality of logical block addresses (LBAs);
track one or more LBAs from among the plurality that are targets of write operations during the service action; and
limit reconstruction to the one or more LBAs that were targets of the write operations during the service action.

11. The computing device of claim 9, wherein the processor is further configured to execute the machine executable code to:
obtain processing resources for use in reconstructing the one or more LBAs; and
prevent another instance of reconstruction from occurring in response to obtaining the processing resources for the service action.

12. The computing device of claim 8, wherein the processor is further configured to execute the machine executable code to:
track a write operation directed toward the storage device during the service action; and
reconstruct a section of the storage device where the write operation is directed.

13. The computing device of claim 8, wherein the processor is further configured to execute the machine executable code to:
reserve input/output operations to the storage device prior to performing the service action to hold any input/output operations to the storage device during the service action; and
release the reservation upon completion of the service action to the storage device.

14. The computing device of claim 8, wherein the processor is further configured to execute the machine executable code to:
query a controller of the volume to determine the redundancy level.

15. A non-transitory machine readable medium having stored thereon instructions for performing a method of performing a service action to a storage device of a volume, comprising machine executable code which when executed by at least one machine, causes the machine to:
receive a service action for performance on a storage device of a volume that utilizes a redundant storage protocol;
perform the service action when the volume supports operation in a degraded mode where the storage device is unavailable during a down time of the service action; and
reconstruct, after completion of the service action, at least one section of the storage device that changed in response to an input/output operation during the down time.

16. The non-transitory machine readable medium of claim 15, comprising further machine executable code that causes the machine to:
determine a redundancy level of the volume associated with the degraded mode.

17. The non-transitory machine readable medium of claim 16, comprising further machine executable code that causes the machine to:
perform the service action when the redundancy level associated with the degraded mode complies with a minimum redundancy specified by the service action.

18. The non-transitory machine readable medium of claim 15, comprising further machine executable code that causes the machine to:
track a write operation directed toward the storage device during the down time; and
reconstruct a section of the storage device where the write operation is directed.

19. The non-transitory machine readable medium of claim 15, comprising further machine executable code that causes the machine to:
divide the storage device into a plurality of logical block addresses (LBAs);
track one or more LBAs from among the plurality that are targets of write operations during the down time; and
limit reconstruction to the one or more LBAs that were targets of the write operations during the down time.

20. The non-transitory machine readable medium of claim 15, comprising further machine executable code that causes the machine to:
obtain a processing resource for use in reconstructing the at least one section; and
prevent another instance of reconstruction from occurring in response to obtaining the processing resource for the service action.
